(19) United States
(12) Patent Application Publication
(10) Pub. No.: US 2020/0285132 A1
(43) Pub. Date: Sep. 10, 2020

(54) LENS MODULE AND ELECTRONIC DEVICE USING THE LENS MODULE

(71) Applicant: TRIPLE WIN TECHNOLOGY(SHENZHEN) CO.LTD., Shenzhen (CN)

(72) Inventors: SHIN-WEN CHEN, Tu-Cheng (TW); JING-WEI LI, Shenzhen (CN); SHENG-JIE DING, Shenzhen (CN); MING LI, Jincheng (CN)

(21) Appl. No.: 16/545,242

(22) Filed: Aug. 20, 2019

(30) Foreign Application Priority Data
Mar. 5, 2019 (CN) 201910165519.8

(51) Int. Cl. G03B 13/36; G02B 7/09; H02K 41/035

(52) U.S. Cl. CPC G03B 13/36; H02K 41/0356; G02B 7/09

(57) ABSTRACT

A lens module with improved structural grounding and adhesion on and to a carrier includes a voice coil motor, a carrier, and a colloid attaching the voice coil motor to the carrier. A wall of the carrier defines at least one hole, and the hole is filled with the colloid to enhance and reinforce a bonding strength between the voice coil motor and the carrier. An electronic device applying such a lens module is also provided.

### FIELD

The subject matter herein generally relates to imaging devices.

### BACKGROUND

Lens modules generally includes a lens unit, a glass filter, a carrier, a voice coil motor, a photosensitive chip, and a circuit board. The voice coil motor is adhered to the carrier usually by glue. However, a bonding strength may be weak and the voice coil motor can easily separated from the carrier, due to small amount of the glue and a small bonding area. The bonding strength can be improved if a glue having high bonding strength and high adhesion safety factor is used, however the cost of the lens module would increase.

Therefore, there is room for improvement.

### BRIEF DESCRIPTION OF THE DRAWINGS

Implementations of the present technology will now be described, by way of embodiments, with reference to the attached figures.

FIG. 1 is an isometric view of a lens module according to an embodiment.

FIG. 2 is an exploded view of the lens module of FIG. 1.

FIG. 3 is an exploded view of the lens module of FIG. 1 in another orientation.

FIG. 4 is a cross-sectional view along line IV-IV of FIG. 1.

FIG. 5 is an isometric view of a voice coil motor, a colloid, and a carrier according to an embodiment of the present disclosure.

FIG. 6 is an isometric view of a voice coil motor, a colloid, and a carrier according to another embodiment of the present disclosure.

FIG. 7 is an isometric view of a voice coil motor, a colloid, and a carrier according to a third embodiment of the present disclosure.

FIG. 8 is a cross-sectional view of the carrier of FIG. 7.

FIG. 9 is a cross-sectional view of a voice coil motor, a colloid, and a carrier according to a fourth embodiment of the present disclosure.

FIG. 10 is an isometric view of a lens module according to another embodiment of the present disclosure.

FIG. 11 is an isometric view of a lens module according to a third embodiment of the present disclosure.

FIG. 12 is a perspective view of an electronic device with any of the lens modules of FIG. 1 to 11 installed thereon.

### DETAILED DESCRIPTION

The present disclosure is made in conjunction with the accompanying drawings. Specific embodiments of the present disclosure are described.

In the following description, when an element is described as being “fixed to” another element, the element can be fixed to the another element with or without intermediate elements. When an element is described as “connecting” another element, the element can be connected to the other element with or without intermediate elements.

Without a given definition otherwise, all terms used have the same meaning as commonly understood by those skilled in the art. The term “and/or” means including any and all combinations of one or more of associated listed items.

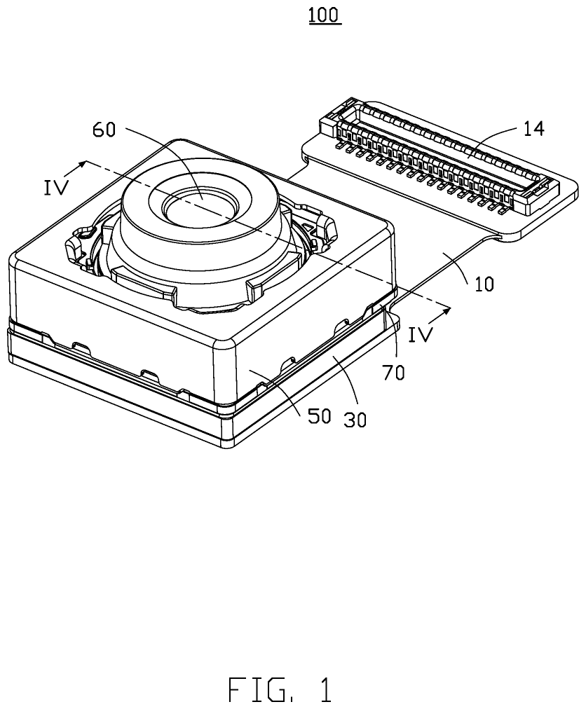

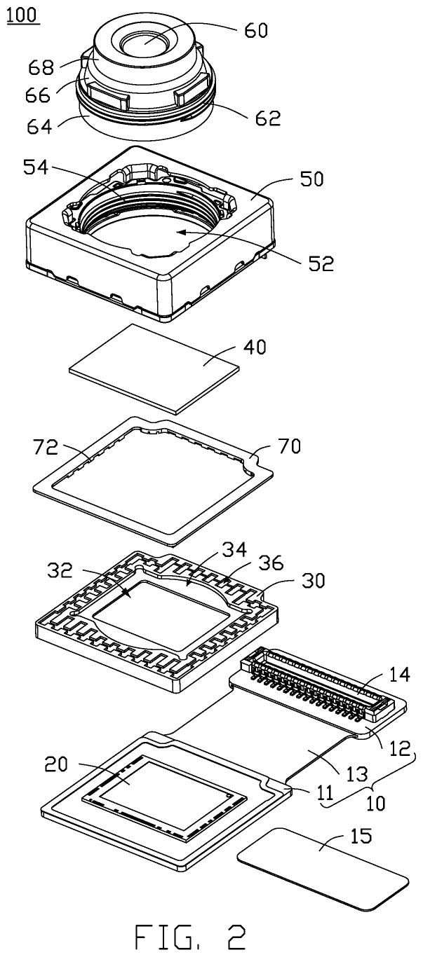

Referring to FIG. 1 and FIG. 2, an embodiment of the present disclosure provides a lens module 100 including a circuit board 10, a photosensitive chip 20, a carrier 30, and a filter 40, a voice coil motor 50, a lens unit 60, and a colloid 70.

In the embodiment, the circuit board 10 is a rigid board, and includes a first hard board portion 11, a second hard board portion 12, and a third hard board portion 13 between the first hard board portion 11 and the second hard board portion 12. A connector 14 is mounted on a surface of the second hard board portion 12. The connector 14 is used to transmit signals between the lens module 100 and other components of an electronic device 200 which carries the lens module 100. The second hard board portion 12 is mounted with a reinforcing plate 15 on another surface. The reinforcing plate 15 is made of a metal such as stainless steel. The reinforcing plate 15 enhances a hardness of the circuit board 10 and facilitates the assembly of the lens module 100. In another embodiment, the locations of the reinforcing plate 15 and the connector 14 are interchangeable.

One surface of the first hard board portion 11 carries the photosensitive chip 20. In the embodiment, the photosensitive chip 20 and the connector 14 are located on a same side of the circuit board 10. The photosensitive chip 20 has a substantially rectangular shape.

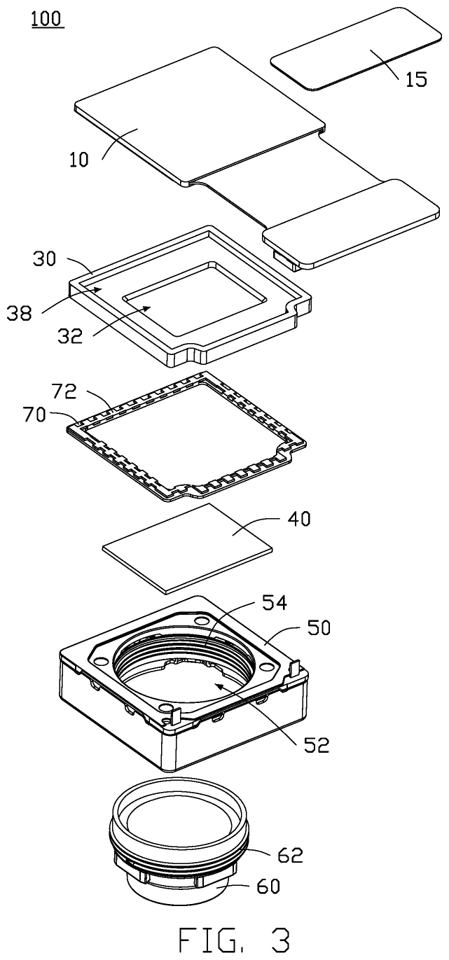

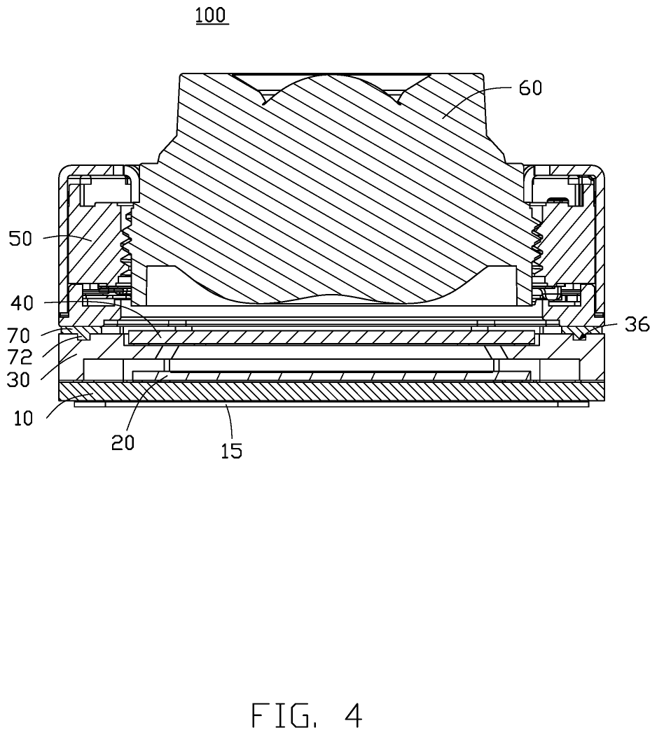

Referring to FIGS. 2-4, the carrier 30 is disposed on the surface of the first hard board portion 11 where the photosensitive chip 20 is located. The carrier 30 and the first hard board portion 11 are connected by the colloid 70.

The carrier 30 has a substantially hollow rectangular structure defining a through hole 32. The carrier 30 defines a first recess 34 away from the circuit board 10 surrounding the through hole 32. The filter 40 is received in the first recess 34 and spaced from the photosensitive chip 20. In the embodiment, the filter 40 is rectangular shaped. The carrier 30 further defines a second recess 38 opposite to the first recess 34 surrounding the through hole 32 for receiving the photosensitive chip 20.

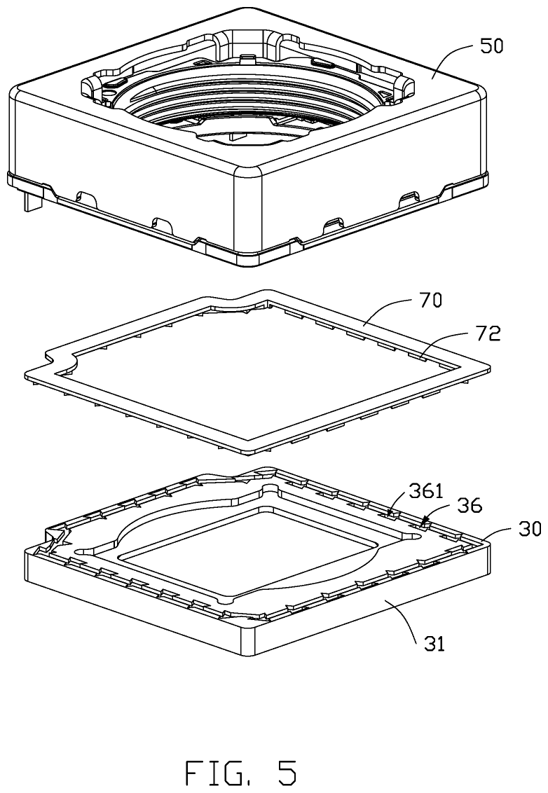

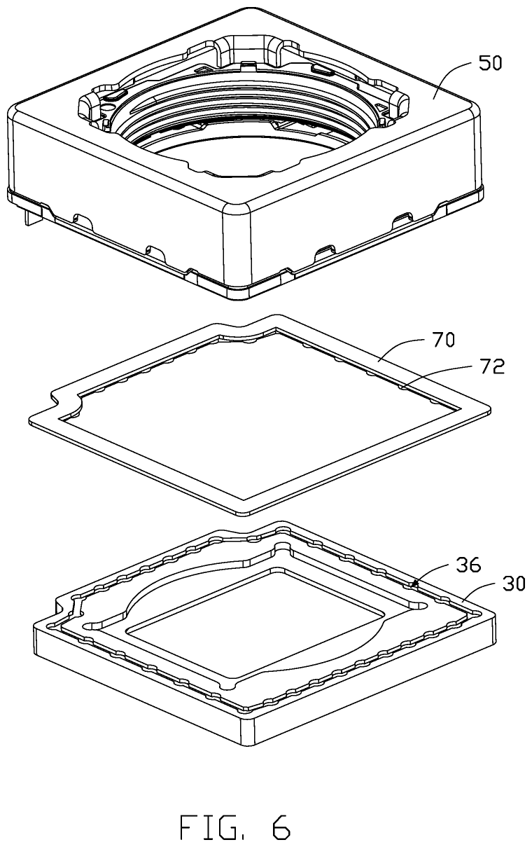

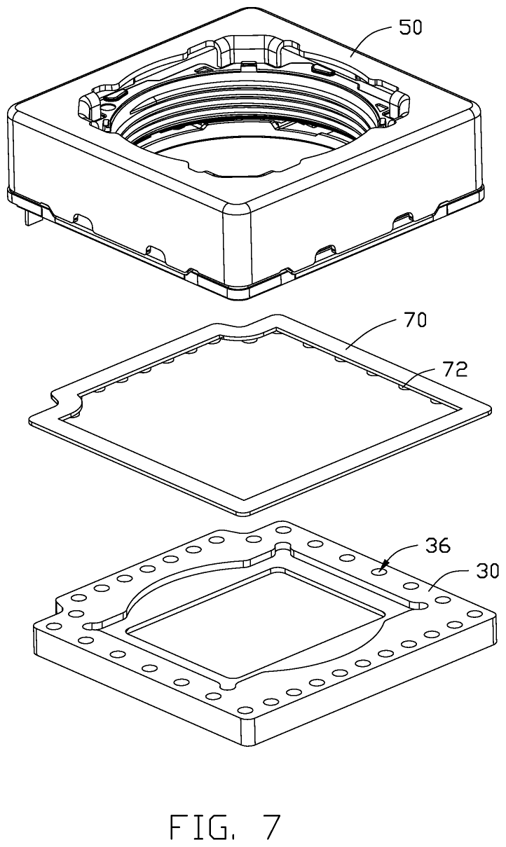

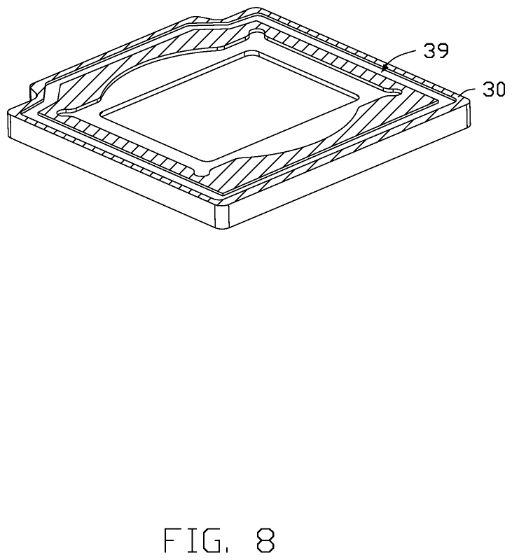

Referring to FIGS. 5-8, the voice coil motor 50 is mounted on the carrier 30 away from the circuit board 10. The carrier 30 includes a wall 31 surrounding the through hole 32. The wall 31 defines at least one hole 36. The hole 36 has an opening 361 which faces the voice coil motor 50. The hole 361 can be any shape including, but not limited to, a regular triangle, circle, ellipse, polygon, star, or the like, or an irregular polygon or the like shape. When a plurality of holes 36 are defined on the wall 31, the holes 36 can be all of a same shape or be of different shapes. The holes 36 can be separated from each other in an embodiment (see FIG. 7), or interconnected with each other in alternative embodiments (see FIGS. 5 and 6). In various embodiments, each of the holes 36 includes a lower portion and an upper portion opposite to the lower portion. The lower portions of the holes 36 are in communication with each other (see FIG. 8), or the upper portions of the holes 36 are interconnected with each other, or both the lower portions and the upper portions of the holes can be interconnected.

Refer to FIGS. 7 and 8, in an embodiment, the upper portions of the holes 36 are separated from each other, and the lower portions of the holes 36 interconnected with each other through a slot 39.

The holes 36 are filled with the colloid 70, thereby increasing the contact area of the carrier 30 with the colloid 70. The colloid 70 forms a plurality of protrusions 72 corresponding to the holes after solidification. A meshing force between the colloid 70 and the carrier 30 is enhanced because of the protrusions 72, thereby maintaining a more than sufficient engagement of the carrier 30 with the voice coil motor 50.

The voice coil motor 50 is mounted on the carrier 30 away from the circuit board 10. The voice coil motor 50 is substantially a rectangular parallelepiped structure, and assembled to the carrier 30 by the colloid 70. In the embodiment, a surface of the voice coil motor 50 contacting the carrier 30 is provided without protrusions.

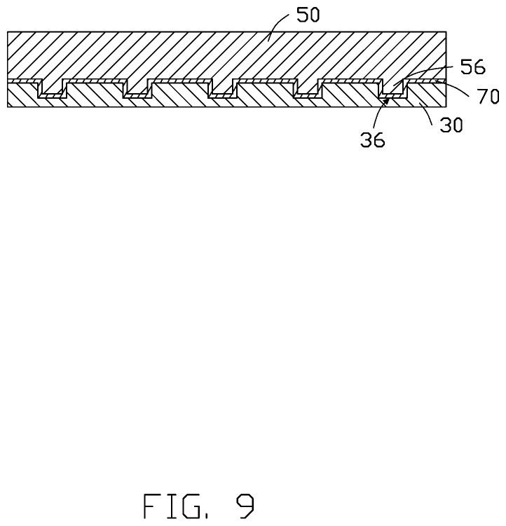

Referring to FIG. 9, in an alternative embodiment, the surface of the voice coil motor 50 contacting the carrier 30 is provided with at least one protrusion 56. The protrusion 56 is received in the hole 36 and engages with the hole 36. The colloid 70 fills gaps between the protrusion 56 and the hole 36, thereby further enhancing the meshing force between the carrier 30 and the voice coil motor 50. The colloid 70 may be elastic to buffer against external jars and impacts applied to the lens module 100 and protect the carrier 30 and the voice coil motor 50.

Referring to FIGS. 2-4, the voice coil motor 50 defines a receiving hole 52. An inner wall of the receiving hole 52 defines a first thread 54. The lens unit 60 is coupled to the voice coil motor 50 through the first thread 54.

The lens unit 60 is partially received in the receiving hole 52 of the voice coil motor 50. In the embodiment, the lens unit 60 includes a first lens portion 64, a second lens portion 66, and a third lens portion 68. The second lens portion 66 is connected between the first lens portion 64 and the third lens portion 68. The first lens portion 64 defines a second thread 62. The second thread 62 engages with the first thread 54 to mount the lens unit 60 in the receiving hole 52. The voice coil motor 50 has an autofocus function that can adjust the position of the lens unit 60 in the voice coil motor 50. The first lens portion 64 and the second lens portion 66 are substantially columnar, and the first lens portion 64 has a diameter larger than that of the second lens portion 66. The third lens portion 68 is substantially in shape of truncated cone.

The first lens portion 64, the second lens portion 66, and the third lens portion 68 are assembled together to form the lens unit 60. In an alternative embodiment, the first lens portion 64, the second lens portion 66, and the third lens portion 68 are integrally molded to form the lens unit 60. The first lens portion 64 can be entirely received in the receiving hole 52 and can be partially rotated out of the receiving hole 52 during use. The second lens portion 66 and the third lens portion 68 are outside of the receiving hole 52.

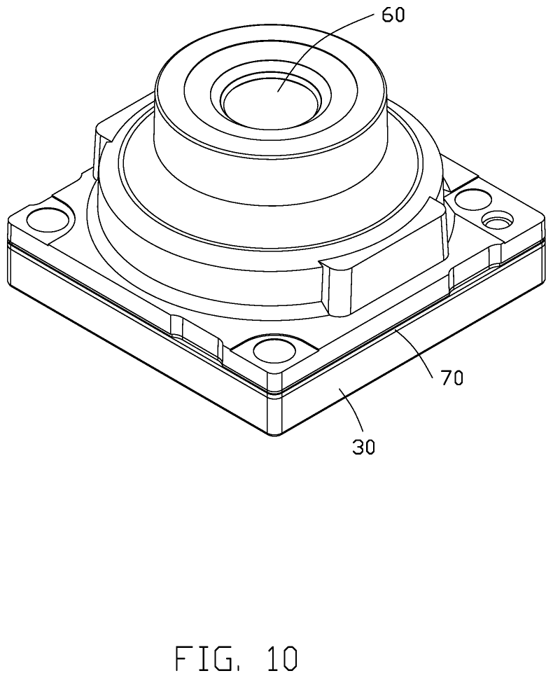

Referring to FIG. 10, in an alternative embodiment, the voice coil motor 50 and a lens holder of the lens unit 60 are integrally formed or molded. The lens unit 60 and the voice coil motor are then mounted to the carrier 30 via the colloid 70.

It can be understood that in an alternative embodiments, the hole 36 can be defined on the voice coil motor 50. The protrusion 56 can be formed on the carrier 30 corresponding to the hole 36 to further increase the meshing force between the voice coil motor 50 and the carrier 30.

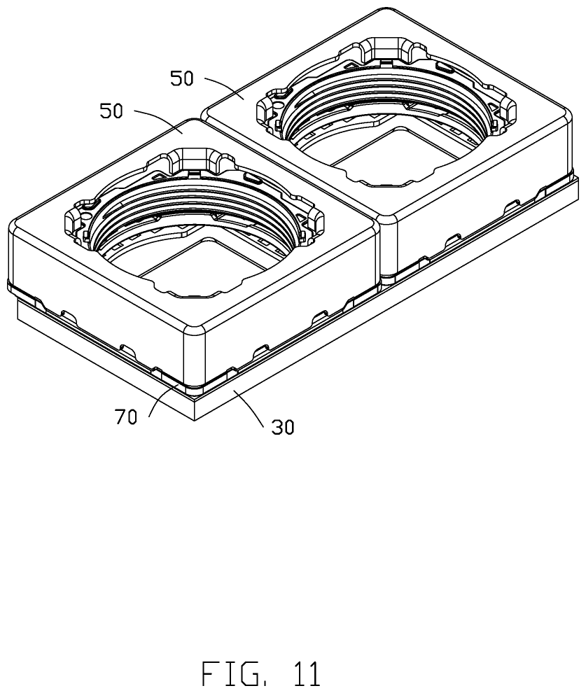

Referring to FIG. 11, in an alternative embodiment, the lens module 100 is a dual-camera module and the carrier 30 carries two voice coil motors 50 and two lens units 60. The two voice coil motors 50 are arranged side by side. In still another embodiment, the carrier 30 can carry more than two voice coil motors 50 and more than two lens units 60.

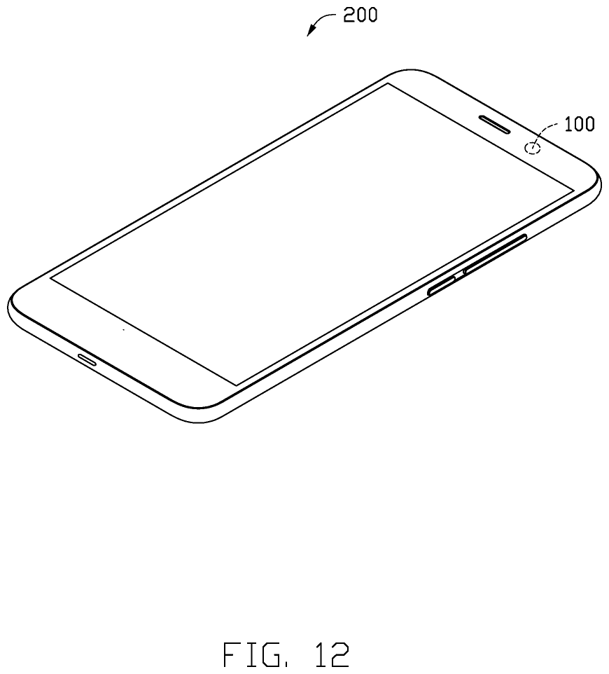

Referring to FIG. 12, the lens module 100 can be applied to various electronic devices 200 equipped with camera modules, such as mobile phones, wearable devices, computer devices, vehicles, and monitoring devices. In this embodiment, the lens module 100 is applied in a mobile phone.

The lens module provided by the present disclosure provides certain improvements. Firstly, by providing at least one hole on the carrier, the colloid is infilled in the hole to increases the meshing force between the colloid and the carrier 30, thereby enhancing the bonding strength of the carrier and the voice coil motor, and reducing the risk of the carrier being separated from the voice coil motor. The reliability and assembly yield of the lens module 100 are improved. Second, the lens module provided by the present disclosure reduces the requirement for adhesiveness of the colloid, and more types of colloid can be used in the lens module. Third, the meshing force between the colloid 70 and the carrier 30 increases the structural foundation between the carrier 30 and the voice coil motor 50 to better meet the requirements of movement.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A lens module comprising a voice coil motor, a carrier, and a colloid attaching the voice coil motor to the carrier, wherein a wall of the carrier defines at least one hole, an opening of the hole faces the voice coil motor and the hole is filled with the colloid.

2. The lens module according to claim 1, wherein the wall of the carrier defines a plurality of holes and the holes are filled with the colloid.

3. The lens module according to claim 2, wherein the plurality of holes are spaced apart from each other on the wall of the carrier.

4. The lens module according to claim 2, wherein the plurality of holes are interconnected with each other.

5. The lens module according to claim 4, wherein each of the holes comprises a lower portion and an upper portion opposite to the lower portion, the lower portions of the plurality of holes are interconnected with each other and/or the upper portions of the plurality of holes are interconnected with each other.

6. The lens module according to claim 1, wherein at least one protrusion is formed on a surface of the voice coil motor contacting the carrier, the protrusion are received in the hole and engaged with the hole, the colloid fills in gaps between the protrusion and the hole.

7. The lens module according to claim 1, wherein the carrier is a hollow structure defining a through hole, the carrier further defines a first recess and a second recess opposite to the first recess, each of the first recess and the second recess surrounds the through hole, the first recess is configured to receive a filter and the second recess is configured to receive a photosensitive chip.

8. The lens module according to claim 1, wherein the lens module further comprises a lens unit, and the lens unit is integrated with the voice coil motor.

9. The lens module according to claim 1, wherein the lens module comprises a plurality of voice coil motors, the carrier carries the plurality of voice coil motors side by side.

10. An electronic device comprising a lens module, the lens module comprising a voice coil motor, a carrier, and a colloid attaching the voice coil motor to the carrier, wherein a wall of the carrier defines at least one hole, an opening of the hole faces the voice coil motor and the hole is filled with the colloid.

11. The electronic device according to claim 10, wherein a plurality of holes are defined on the wall of the carrier and the holes are filled with the colloid.

12. The electronic device according to claim 11, wherein the plurality of holes are spaced apart from each other on the wall of the carrier.

13. The electronic device according to claim 11, wherein the plurality of holes are interconnected with each other.

14. The electronic device according to claim 13, wherein each of the holes comprises a lower portion and an upper portion opposite to the lower portion, the lower portions of the plurality of holes are interconnected with each other and/or the upper portions of the plurality of holes are interconnected with each other.

15. The electronic device according to claim 10, wherein at least one protrusion is formed on a surface of the voice coil motor contacting the carrier, the protrusion are received in the hole and engaged with the hole, the colloid fills in gaps between the protrusion and the hole.

16. The electronic device according to claim 10, wherein the carrier is a hollow structure defining a through hole, the carrier further defines a first recess and a second recess opposite to the first recess, each of the first recess and the second recess surrounds the through hole, the first recess receives a filter and the second recess receives a photosensitive chip.

17. The electronic device according to claim 10, wherein the lens module further comprises a lens unit, and the lens unit is integrated with the voice coil motor.

18. The electronic device according to claim 10, wherein the lens module comprises a plurality of voice coil motors, the carrier carries the plurality of voice coil motors side by side.
